(19) United States
(12) Patent Application Publication
(10) Pub. No.: US 2021/0185638 A1
(43) Pub. Date: Jun. 17, 2021

(54) PREVENTING NOTIFICATION LOSS DURING TEMPORARY NETWORK DISCONNECTION

(71) Applicant: Microsoft Technology Licensing, LLC, Redmond, WA (US)

(72) Inventors: Rajeev Ranjan Pathak, Prague (CZ); Pavel Tic, Revnice (CZ); Ilya Korolev, Prague (CZ); Sergey Anikin, Prague (CZ); Anton Audzei, Mochov (CZ)

(73) Assignee: Microsoft Technology Licensing, LLC, Redmond, WA (US)

(21) Appl. No.: 16/717,978

(22) Filed: Dec. 17, 2019

(51) Int. Cl. H04W 68/02; H04L 29/06; H04L 29/08; H04W 72/12

(52) U.S. Cl. CPC H04W 68/02; H04L 67/42; H04W 72/1242; H04L 67/18; H04L 67/2842; H04L 69/329

(57) ABSTRACT

Techniques are described for preventing loss of notifications during network disconnections (e.g., during temporary network disconnections that last a number of seconds or minutes) for network communication scenarios where the client device and service have a persistent network connection. For example, notifications can be stored in a message store while a client device is disconnected from a network (e.g., from a network communication channel). The notifications can be stored in association with a time-to-live (TTL) value that is associated with a notification type of the notification and/or with other notification ordering parameters. When the client device reconnects to the network, the stored notifications can be sent to the client device in an order that is based at least in part on the TTL values of the notifications and/or other notification ordering parameters.

### BACKGROUND

Real-time communication services are used to communicate audio, video, chat, and other types of data via a computer network, such as the internet. In typical real-time communication scenarios, the service sends various types of notifications to the client device. For example, a service may send a call notification to the client device to alert the user of the client device of a phone call (e.g., a notification to initiate an audible and/or visual ringing notification at the client device for 30 seconds).

Typically, the service and the client device communicate via a network connection. However, in some situations the network connection can be disrupted for a period of time (e.g., a number of seconds or minutes). Disruptions can occur due to network conditions or other issues. Mobile devices can be particularly prone to network connection disruptions. For example, a smart phone may be traveling in a geographical location where cellular connection is unreliable and experience intermittent network disconnections, or the cell phone may be traveling in a tunnel and lose network connection for a number of seconds.

When a network disconnection occurs with a network connection between the service and the client device, an error message is commonly sent to the service. The service then has the responsibility of handling the error message. In some solutions, the service tries to retransmit the original notification. However, the client device may still be disconnected, and the retransmitted notification will once again fail.

Therefore, there exists ample opportunity for improvement in technologies related to handling notifications.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Technologies are described for preventing loss of notifications during network disconnections. For example, operations can comprise determining that a client device has disconnected from a network communication channel Operations can be performed for each of a plurality of notifications received for the client device while the client device is disconnected. For example, while the client device is disconnected, a notification type can be determined for the notification, based at least in part on the determined notification type, a time-to-live (TTL) value can be assigned to the notification (e.g., different notification types are assigned different TTL values), and the notification can be stored in a message store in association with its assigned TTL value. Operations can be performed responsive to determining that the client device has reconnected to the network communication channel. For example, an order can be determined for sending the notifications stored in the message store to the client device, where determining the order is based at least in part on the TTL values of the notifications stored in the message store. The notifications stored in the message store can be sent, via the network communication channel, to the client device in the determined order.

As another example, operations can comprise determining that a client device has disconnected from a network communication channel between a computing device and the client device. The operations can further comprise, for each of a plurality of notifications received for the client device while the client device is disconnected: determining a notification type of the notification, based at least in part on the determined notification type, assigning a time-to-live (TTL) value to the notification, where different notification types are assigned different TTL values, determining a notification class of the notification that indicates whether the notification is ephemeral or non-ephemeral, determining a notification priority based at least in part on the notification type of the notification and the notification class of the notification, and storing the notification in a message store in association with its assigned TTL value and its associated notification priority. The operations can further comprise, responsive to determining that the client device has reconnected to the network communication channel: determining an order for sending the notifications stored in the message store to the client device, where determining the order is based at least in part on the TTL values and notification priorities of the notifications stored in the message store, and sending, via the network communication channel, the notifications stored in the message store to the client device in the determined order.

As described herein, a variety of other features and advantages can be incorporated into the technologies as desired.

### BRIEF DESCRIPTION OF THE DRAWINGS

FIG. 1 is a diagram depicting an example environment for preventing loss of notifications during network disconnections.

FIG. 2 is a diagram depicting an example environment including a notification transport service.

FIG. 3 is a flowchart of an example method for preventing loss of notifications during network disconnections.

FIG. 4 is a flowchart of an example method for preventing loss of notifications during network disconnections.

FIG. 5 is a diagram of an example computing system in which some described embodiments can be implemented.

FIG. 6 is an example mobile device that can be used in conjunction with the technologies described herein.

FIG. 7 is an example cloud-support environment that can be used in conjunction with the technologies described herein.

### DETAILED DESCRIPTION

### Overview

As described herein, various techniques and solutions can be applied for preventing loss of notifications during network disconnections (e.g., during temporary network disconnections that last a number of seconds or minutes). For example, notifications can be stored in a message store while a client device is disconnected from a network (e.g., from a persistent network communication channel). The notifications can be stored in association with a time-to-live (TTL) value that is associated with a notification type of the notification and/or with other notification ordering parameters. When the client device reconnects to the network, the stored notifications can be sent to the client device in an order that is based at least in part on the TTL values of the notifications and/or other notification ordering parameters.

In previous solutions, when a notification failed, a failure message was communicated to the service that originated the notification. It was then the responsibility of the service to take action (e.g., to retransmit the notification). However, the service may not be able to efficiently or effectively retransmit the notification. For example, the service may try to retransmit the notification while the client device is unavailable (e.g., disconnected from the network), which is inefficient in terms of computing resources (e.g., network bandwidth and processing resources). In addition, the service may not have the resources to manage multiple notifications that need to be retransmitted. Furthermore, in some situations, the service may not be able to retransmit the notification (e.g., a call ringing notification may not be retransmitted as the call flow can end when an error message is received). Finally, the service may not retransmit notifications in an efficient order (e.g., the service may transmit an older notification first even if the older notification is no longer relevant to the client device).

In addition, in previous solutions, when the client device reconnects after being disconnected, it requests notifications that it may have missed during the disconnection. While the originating service is able to transmit non-ephemeral notifications, the originating service cannot retransmit ephemeral notifications. This results in a loss of ephemeral notifications while the client device is disconnected.

The technologies described herein can be applied to prevent loss of notifications during network disconnections, and can provide improvements in terms of reliability and efficiency. For example, savings in terms of computing resources (e.g., networking resources, processing resources, etc.) can be realized by saving notifications while it is determined that client devices are disconnected (e.g., saving the notifications for a limited amount of time, such up to two seconds) and not trying to retransmit the notifications while the client devices remain disconnected. Furthermore, notifications can be transmitted to client devices more efficiently when they reconnect. For example, notification ordering parameters can be determined and associated with the saved notifications. The notification ordering parameters can be used to determine an order to send the notifications when the client device reconnects.

### Notifications

In the technologies described herein, notifications are sent to a client device over a network communication channel. In some implementations, notifications are sent from a service (also referred to as a service endpoint) to a client device. Notifications cause the client device to perform some activity, which may or may not be visible to the user of the client device. For example, a call ringing notification causes the client device to initiate a ringing action.

Notifications are used to notify a client device of an event. For example, a call ringing notification can be sent from a calling service (e.g., a VoIP calling service) to inform the client device of a phone call. In response to the call ringing notification, the client device can present a ringing alert of the incoming phone call (e.g., via a visual, audible, and/or haptic alert) for a period of time (e.g., present the ringing alert for a number of seconds, such as 30 seconds).

Various types of notifications can be provided to client devices to alert the client devices of various events. One type of notification is a call ringing notification which alerts the client device to an incoming phone call. Another type of notification is a presence change notification that informs the client device of a change in presence (e.g., that a user's presence has changed status, such as a change to available, busy, do not disturb, etc.). Another type of notification is a location update notification that informs the client device of a change in location (e.g., a change in geographical location, which could include a current GPS location). Another type of notification is a chat completion notification (e.g., alerting the user to possible next words or phrases for a chat message being entered). Another type of notification is message notification that alerts the client device of an incoming message (e.g., a text or chat message). Another type of notification is a file notification that alerts the client device that a file is being shared. Another type of notification is a contact notification that alerts the client device of new or updated contact information. Another type of notification is a policies notification that alerts the client device of new or updated policies (e.g., permissions). Another type of notification is a profile notification that alerts the client device of new or updated profile information (e.g., change in user name, email address, phone number, and/or other profile information).

In some implementations, there are two classes of notifications: ephemeral notifications and non-ephemeral notifications. Ephemeral notifications are a class of notifications that are not persisted by the service endpoints that originate the ephemeral notifications. In other words, if a service endpoint sends an ephemeral notification and it cannot be delivered to the client device (e.g., an error message is received), the service endpoint will not re-transmit the ephemeral notification. Ephemeral notifications are linked to non-persistent user action (e.g., the user action is not persistent at the service endpoint or it is overwritten, such as call notifications or presence updates). Ephemeral notifications are also referred to as real-time notifications. One example of an ephemeral notification is a call ringing notification. For example, a service endpoint can send a call ringing notification to a client device alerting the client device to an incoming call. If the call ringing notification cannot be delivered to the client device (e.g., due to a network connection issue), the service endpoint will not try to re-transmit the call ringing notification later (e.g., it would not make sense to re-transmit the call ringing notification later because the call ringing notification is only relevant for a short period of time, typically a number of seconds). Other types of ephemeral notifications include presence change notifications, location update notifications, and chat completion notifications.

Non-ephemeral notifications are a class of notifications that are persisted by the service endpoints that originate the non-ephemeral notifications. In other words, if a service sends a non-ephemeral notification and it cannot be delivered to the client device (e.g., an error message is received), the service endpoint will re-transmit the ephemeral notification at a later time (e.g., until the non-ephemeral notification is successfully received by the client device). Non-ephemeral notifications are linked to user actions that are persisted by the service endpoint, such as chat messages or profile or contact data, and because they are persisted at the service endpoint they can be resynced when the client device reconnects. Non-ephemeral notifications are relevant for a relatively longer time than ephemeral notifications. One example of a non-ephemeral notification is a profile notification that indicates an update to a user's profile information (e.g., to the user's display name, picture, and/or to other profile information associated with the user or user's account). For example, a user could update the user's profile (e.g., update the user's display name, picture, and/or other profile information associated with the user or the user's account). In response, the service endpoint sends a profile notification to the user's device (e.g., to the user's smart phone, computer, tablet, and/or to other client devices that store the user's profile). If the notification fails (e.g., if the service endpoint does not receive an acknowledgement indicating that the profile notification was successfully received), then the service endpoint will re-send the profile update (e.g., on a periodic basis) until it is successfully received. For example, the service endpoint can switch sending the profile notification from a persistent communication channel to a push communication channel.

Ephemeral (real-time) notifications are a type of notification that are sent via a network communication channel that maintains a persistent connection with a client device (e.g., a persistent real-time network communication channel). A persistent network communication channel is different from a push network communication channel that is used when the client is offline (e.g., when a particular application is not running on the client device or when the client device has no active network connection). While it is possible to send ephemeral notifications via a push notification channel, it is not an efficient or effective way to transmit such notifications (e.g., push channels can be inherently unreliable and can cause more delay in notification delivery, and can result in the notifications being no longer relevant if and when they are received).

### Notification Ordering Parameters

In the technologies described herein, notification ordering parameters can be determined for notifications. One type of notification ordering parameter is a time-to-live (TTL) value. A TTL value can be implemented as a counter or timestamp that is assigned to a notification when it is received (e.g., from the service endpoint). TTL values can be determined based on attributes of the notifications (e.g., the notification class, the notification type, and/or other attributes associated with the notifications). For example, a call ringing notification can be assigned a TTL value of 30 seconds. A presence notification can be assigned a relatively higher TTL value (e.g., a value of 1 or 2 minutes). In this way, different notification types can be assigned different notification values (e.g., each type of notification can be associated with its own TTL value). The TTL value can indicate the length of time for which the notification is relevant and for which the notification should be stored in the message store (e.g., the lifespan of the notification). After a length of time corresponding to the TTL value has passed, the notification may no longer be relevant (e.g., it can be removed from the message store and not delivered to the client device). For example, a call ringing notification that is assigned a TTL value of 30 seconds and stored in a message store can be removed (deleted) from the message store after 30 seconds has passed and not delivered to the client device (e.g., because the call ringing event has ended).

In some implementations, notifications that are stored in a message store are ordered for sending to a client device based at least in part on TTL values of the notifications stored in the message store. For example, notifications with smaller TTL values can be sent to client devices before notifications with larger TTL values. In some implementations, TTL values are decremented while the associated notifications remain in the message store and ordering is based on the remaining TTL values. For example, when a call ringing notification is stored in the message store it can be assigned a TTL value of 30 seconds. After 10 seconds, the TTL value can reduced to 20 seconds (e.g., indicating that the notification will be relevant for 20 more seconds), and the current TTL value of 20 seconds can be used if the client device reconnects and ordering of notifications is performed. Ordering the notifications by their currently remaining TTL value can provide more efficient delivery of stored notifications to client devices. For example, a call ringing notification that only has 8 seconds of TTL remaining can be delivered to a client device before a presence notification that has 45 seconds of TTL remaining.

Another type of notification ordering parameter is notification priority. A notification priority can be assigned to a notification based on the relative importance of the notification. For example, different priorities can be assigned to different notification types (e.g., the notification types can be divided into high priority, medium priority, and low priority groups). For example, a call ringing notification can be assigned high priority while a presence notification can be assigned medium priority.

In some implementations, notifications that are stored in a message store are ordered for sending to a client device based at least in part on notification priorities of the notifications stored in the message store. For example, notifications with higher priority can be sent to the client device before notifications with lower priorities. Ordering notifications in this manner can provide more efficient delivery of higher priority notifications. For example, a call ringing notification (e.g., which can be high priority because it is relevant for only a short time period) can be delivered to the client device before a location notification (e.g., which can have a lower priority).

Another type of notification ordering parameter is notification size (also referred to as message size). A notification size (e.g., a relative size, a specific value such as a number of bytes, and/or another indication of size) can be assigned to the notification based on the size of the notification (indicating how much data needs to be transmitted over the network to communicate the notification). For example, a call ringing notification may have a notification size in terms of bytes while a profile update notification may have a notification size in terms of kilobytes.

In some implementations, notifications that are stored in a message store are ordered for sending to a client device based at least in part on notification sizes of the notifications stored in the message store. For example, notifications with relatively smaller notification sizes can be sent to the client device before notifications with relatively larger notification sizes. Ordering notifications in this manner can provide more efficient delivery of stored notifications (e.g., smaller notifications do not have to wait for larger notifications to be delivered).

Another type of notification ordering parameter is client type (also referred to a client device type). The client type parameter indicates the type of client device that is receiving the notification. For example, the type of client device could be a smart phone, a computer, a table, a media console, or another type of device. The client type could be more specific, such as indicating a particular make or model of smart phone, or particular smart phone features or specifications. For example, a call ringing notification that is being delivered to a smart phone can be associated with a client type of smart phone, while a call ringing notification that is being delivered to a desktop computer could be associated with a client type of desktop computer.

In some implementations, notifications that are stored in a message store are ordered for sending to a client device based at least in part on client type of the notifications stored in the message store. For example, notifications with a particular client type (or types) can be delivered to the client device before notifications with another client type (or types). Client types can be arranged in an order (e.g., from sending first to sending last). For example, a call ringing notification that is associated with a smart phone client type can be delivered to the client device before a call ringing notification that is associated with a desktop computer client type.

In some implementations, multiple notification ordering parameters are used, separately or in combination, when determining the order in which to send stored notifications to client devices. For example, stored notifications can first be grouped by priority (e.g., high, medium, and low) for sending to a client device, and within each priority group the notifications can be ordered by TTL value (e.g., starting with lowest current remaining TTL value). In some implementations, a combination of TTL value, priority, notification size, and client type are used when determining the ordering.

One or more notification ordering parameters can be stored in a message store in association with the notifications. For example, a particular call ringing notification can be stored in the message store and associated with a specific TTL value (e.g., 30 seconds), a priority (e.g., high), a message size (e.g., 20 bytes), a client type (e.g., smart phone), and/or in association with other notification ordering parameters.

### Environments for Preventing Loss of Notifications During Network Disconnections

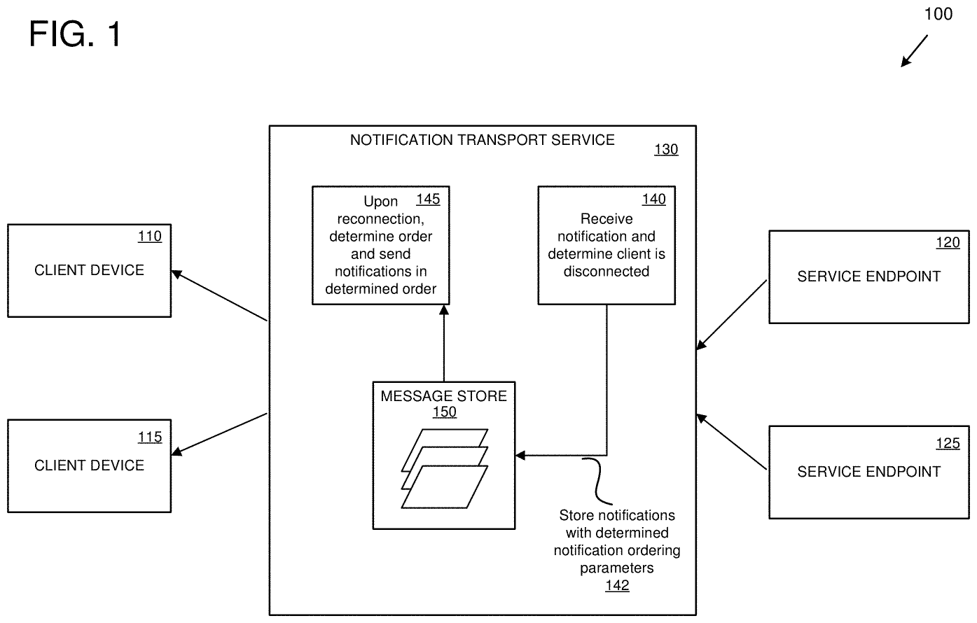

FIG. 1 is a diagram depicting an example environment 100 for preventing loss of notifications during network disconnections. The example environment 100 depicts two example service endpoints, service endpoint 120 and service endpoint 125. While only two example service endpoints are depicted, the example environment 100 can include any number of service endpoints. The service endpoints can be endpoints for any type of service that includes delivery of notifications to client devices. For example, service endpoint 120 could be a real-time communication service (e.g., implemented by a variety of hardware and/or software resources, such as physical servers, virtual servers, storage resources, networking resources, etc.) that provides VoIP audio and video calling, messaging, file sharing, etc. The service endpoints could be provided by the same organization or by different organizations.

The service endpoints communicate over networks (e.g., comprising public networks, private networks, wide area networks, local area networks, the Internet, and/or other types of computer networks) with a notification transport service 130. The notification transport service 130 communicates over networks (e.g., comprising public networks, private networks, wide area networks, local area networks, the Internet, and/or other types of computer networks) with client devices, such as client device 110 and client device 115. The client devices can be smart phones, computers, tablets, media consoles, or other types of computing devices. While only two example client devices are depicted, the example environment 100 can include any number of client devices. In some implementations, the service endpoints communicate with the client devices over a persistent network communication channel that maintains a persistent (e.g., real-time) network connection with the client devices (e.g., via the notification transport service 130). In some implementations, the notification transport service 130 maintains a persistent real-time network communication channel with the client devices. The notification transport service 130 can participate in managing the communication between the service endpoints and the client devices (e.g., by receiving notifications from the service endpoints, storing notifications for disconnected client devices, and delivering stored notifications for client devices that reconnect).

The notification transport service 130 performs operations for preventing loss of notifications during network disconnections. For example, at 140, the notification transport service 130 receives a notification from a service endpoint (e.g., from service endpoint 120) and determines if the client device (e.g., client device 110) that will be receiving the notification is disconnected. If the client device is not disconnected (e.g., if the persistent communication channel is active), then the notification transport service 130 sends the notification to the client device (e.g., without storing the notification). However, if the client device is disconnected, the notification transport service 130 stores the notification in a message store 150 (e.g., implemented as a database or another type of data store) along with determined notification ordering parameters, as depicted at 142. For example, the notification transport service 130 can determine notification ordering parameters (e.g., TTL values, priority, message size, client type, and/or other notification ordering parameters) and store them in association with the notification in the message store 150.

The notification transport service 130 can be implemented by a variety of hardware and/or software services (e.g., physical servers, virtual servers, storage resources, networking resources, etc.), which can be localized or distributed (e.g., implemented by different resources at different locations within a network). For example, the notification transport service 130 can be implemented as a cloud service that receives notifications from remote service endpoints for delivery to remote client devices.

The notification transport service 130 can determine if a given client device is disconnected in a variety of ways. For example, the notification transport service 130 can send keepalive packets to the client device on a periodic basis to determine whether the network channel between the notification transport service 130 and the client device (e.g., client device 110) is active (i.e., not disconnected or broken).

When a client device reconnects (e.g., when a client device reestablishes its persistent network communication channel with the notification transport service 130), the notification transport service 130 determines if there are any notifications waiting in the message store 150 for the client device. If notifications are waiting, the notification transport service 130 determines an order for sending the stored notifications to the client device and sends the notifications in the determined order, as depicted at 145. For example, the notification transport service 130 uses one or more of the notification ordering parameters stored in association with the notifications to determine the order.

The notification transport service 130 can support a number of network communication channels (e.g., a number of persistent network communication channels and/or other types of network communication channels). For example, the notification transport service 130 maintains a first persistent real-time network communication channel with client device 110 (e.g., a smart phone that communicates using a cellular network connection) and a second persistent real-time network communication channel with client device 115 (e.g., a desktop computer that communicates over a WiFi network connection). The notification transport service 130 can communicate with client devices using a variety of network protocols (e.g., a variety of real-time communication protocols) over a variety of networks.

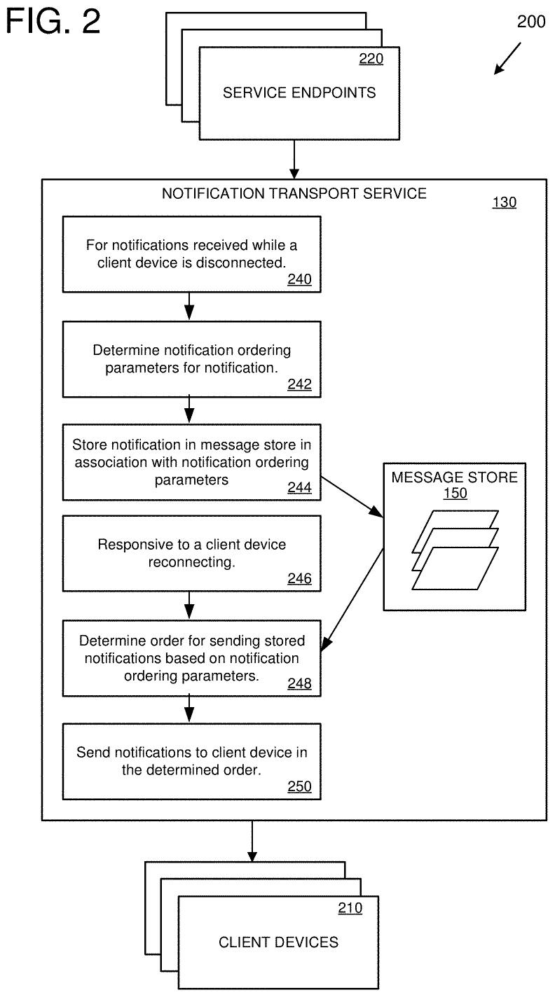

FIG. 2 is a diagram depicting an example environment 200 including a notification transport service 130 along with example operations that the notification transport 130 service can perform. In the example environment 200, service endpoints 220 send notifications to the notification transport service 130 for delivery to client devices 210. The service endpoints 220 can be endpoints for any type of service that includes delivery of notifications to client devices. The service endpoints 220 can include the example service endpoints 120 and 125. The service endpoints 220 can be implemented by a variety of hardware and/or software resources, such as physical servers, virtual servers, storage resources, networking resources, etc. The client devices 210 can be any type of computing devices (e.g., smart phones, computers, tablets, media devices, etc.). The client devices 210 can include the example client devices 110 and 115.

The notification transport service 130 performs operations for preventing loss of notifications during network disconnections. For example, the notification transport service 130 can perform one or more of the operations depicted at 240-250. For example, at 240, a number of operations are performed for notifications that are received while a client device is disconnected (e.g., while the notification transport service 130 detects that the client device is disconnected from a persistent real-time network communication channel that the client device maintains with the notification transport service 130). Specifically, while the client device is disconnected, at 242, one or more notification ordering parameters are determined for the notification (e.g., a TTL value, a priority, a notification size, a client device type, and/or other notification ordering parameters). The notification ordering parameters can be determined based at least in part on the notification type of the notification (e.g., whether the notification is a call ringing notification, a presence notification, a profile update notification, etc.) and/or notification class (e.g., whether the notification is an ephemeral notification, a non-ephemeral notification, and/or another class of notification). At 244, the notification is stored in the message store 150 in association with the notification ordering parameters that were determined for that notification.

At 246, a number of operations are performed when a client device reconnects. For example, the operations at 248 and 250 can be performed when the notification transport service 130 detects that a client device has reconnected (e.g., to a persistent real-time network communication channel between the client device and the notification transport service 130). At 248, an order for sending stored notifications is determined based at least in part on notification ordering parameters associated with the stored notifications. For example, the message store 150 can be queried and any stored notifications that are waiting for the given client device to reconnect can be identified and their associated notification ordering parameters can be analyzed to determine the order. At 250, The notifications are sent to the client device in the determined order.

### Methods for Preventing Loss of Notifications During Network Disconnections

In any of the examples herein, methods can be provided for preventing loss of notifications during network disconnections.

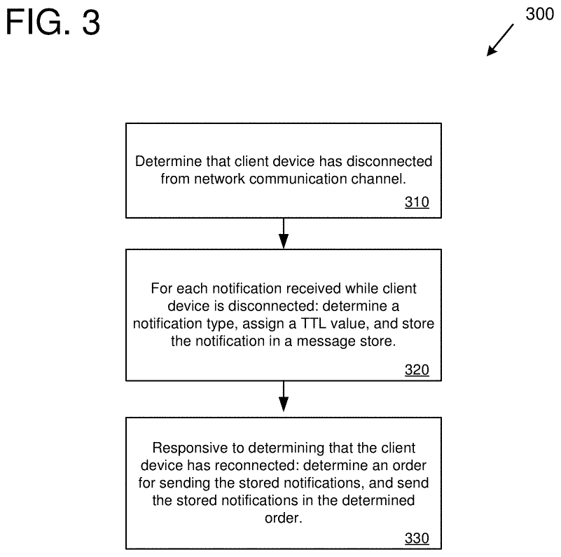

FIG. 3 is a flowchart of an example method 300 for preventing loss of notifications during network disconnections. For example, the example method 300 can be performed by a notification transport service, such as notification transport service 130.

At 310, it is determined that a client device has disconnected from a network communication channel. The network communication channel can be a persistent network communication channel between the client device and a service that provides notifications (e.g., notification transport service 130). The disconnection can be determined based on network connection technologies, such as keepalive messages. For example, the client device may become disconnected form the network communication channel when the client device switches its network connection (e.g., when a smart phone switches to a new cell tower, when a computing device moves between WiFi access points) or when the client device loses connectivity for another reason (e.g., when the device travels through a tunnel or otherwise loses wireless connectivity, due to a network issue, etc.).

At 320, a number of operations are performed for each notification that is received while the client device is disconnected. The notifications can comprise ephemeral notifications. The operations include determining a notification type of the notification. Based at least in part on the determined notification type, a TTL value is assigned to the notification. The notification is then stored in a message store in association with this assigned TTL value. Other notification ordering parameters can be determined in addition to, or instead of, a TTL value and stored in association with the notification. In addition, the notification ordering parameters can be determined based at least in part on notification class.

At 330, a number of operations are performed responsive to determining that the client device has reconnected. The operations include determining an order for sending the stored notifications (e.g., based at least in part on the associated TTL values and/or other notification ordering parameters). The stored notifications are then sent to the client device in the determined order.

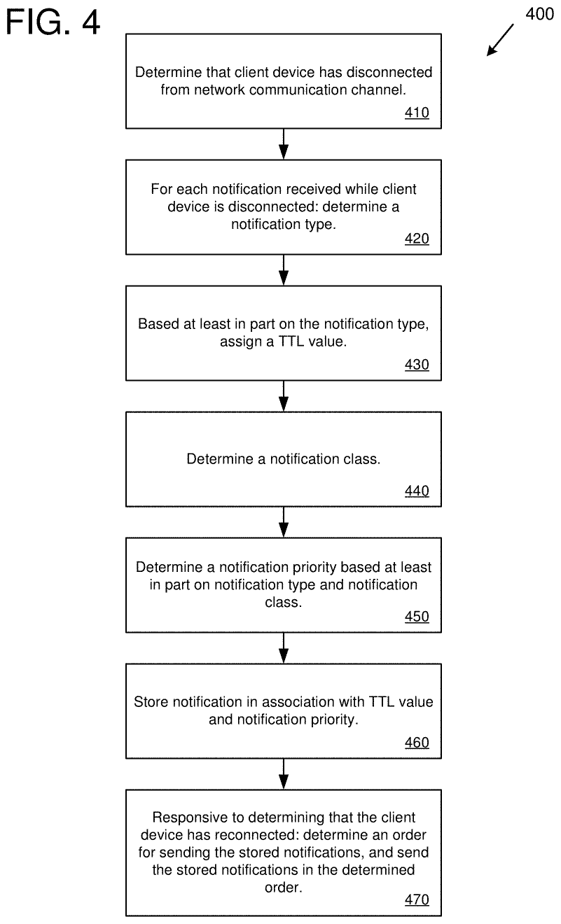

FIG. 4 is a flowchart of an example method 400 for preventing loss of notifications during network disconnections. For example, the example method 400 can be performed by a notification transport service, such as notification transport service 130.

At 410, it is determined that a client device has disconnected from a network communication channel. The network communication channel can be a persistent network communication channel between the client device and a service that provides notifications (e.g., notification transport service 130). The disconnection can be determined based on network connection technologies, such as keepalive messages. For example, the client device may become disconnected form the network communication channel when the client device switches its network connection (e.g., when a smart phone switches to a new cell tower, when a computing device moves between WiFi access points) or when the client device loses connectivity for another reason (e.g., when the device travels through a tunnel or otherwise loses wireless connectivity, due to a network issue, etc.).

At 420, a number of operations are performed for each notification that is received while the client device is disconnected. The notifications can comprise ephemeral notifications. The operations include determining a notification type of the notification. At 430, based at least in part on the determined notification type, a TTL value is assigned to the notification. At 440, a notification class is determined for the notification. In some implementations, the notification class is determined to be ephemeral or non-ephemeral. At 450, a notification priority is determined for the notification based at least in part on the notification type (determined at 420) and the notification class (determined at 440). At 460, the notification is stored (e.g., in a message store) along with its associated TTL value and notification priority. Other notification ordering parameters can be determined in addition to, or instead of, a TTL value and notification priority, and stored in association with the notification.

At 470, a number of operations are performed responsive to determining that the client device has reconnected. The operations include determining an order for sending the stored notifications (e.g., based at least in part on the associated TTL values, priorities, and/or other notification ordering parameters). The stored notifications are then sent to the client device in the determined order.

### Computing Systems

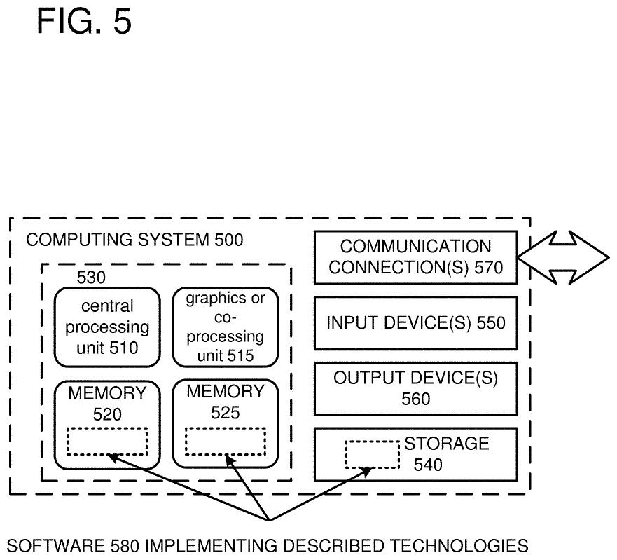

FIG. 5 depicts a generalized example of a suitable computing system 500 in which the described technologies may be implemented. The computing system 500 is not intended to suggest any limitation as to scope of use or functionality, as the technologies may be implemented in diverse general-purpose or special-purpose computing systems.

With reference to FIG. 5, the computing system 500 includes one or more processing units 510, 515 and memory 520, 525. In FIG. 5, this basic configuration 530 is included within a dashed line. The processing units 510, 515 execute computer-executable instructions. A processing unit can be a general-purpose central processing unit (CPU), processor in an application-specific integrated circuit (ASIC), or any other type of processor. A processing unit can also comprise multiple processors. In a multi-processing system, multiple processing units execute computer-executable instructions to increase processing power. For example, FIG. 5 shows a central processing unit 510 as well as a graphics processing unit or co-processing unit 515. The tangible memory 520, 525 may be volatile memory (e.g., registers, cache, RAM), non-volatile memory (e.g., ROM, EEPROM, flash memory, etc.), or some combination of the two, accessible by the processing unit(s). The memory 520, 525 stores software 580 implementing one or more technologies described herein, in the form of computer-executable instructions suitable for execution by the processing unit(s).

A computing system may have additional features. For example, the computing system 500 includes storage 540, one or more input devices 550, one or more output devices 560, and one or more communication connections 570. An interconnection mechanism (not shown) such as a bus, controller, or network interconnects the components of the computing system 500. Typically, operating system software (not shown) provides an operating environment for other software executing in the computing system 500, and coordinates activities of the components of the computing system 500.

The tangible storage 540 may be removable or non-removable, and includes magnetic disks, magnetic tapes or cassettes, CD-ROMs, DVDs, or any other medium which can be used to store information and which can be accessed within the computing system 500. The storage 540 stores instructions for the software 580 implementing one or more technologies described herein.

The input device(s) 550 may be a touch input device such as a keyboard, mouse, pen, or trackball, a voice input device, a scanning device, or another device that provides input to the computing system 500. For video encoding, the input device(s) 550 may be a camera, video card, TV tuner card, or similar device that accepts video input in analog or digital form, or a CD-ROM or CD-RW that reads video samples into the computing system 500. The output device(s) 560 may be a display, printer, speaker, CD-writer, or another device that provides output from the computing system 500.

The communication connection(s) 570 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The technologies can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Mobile Device

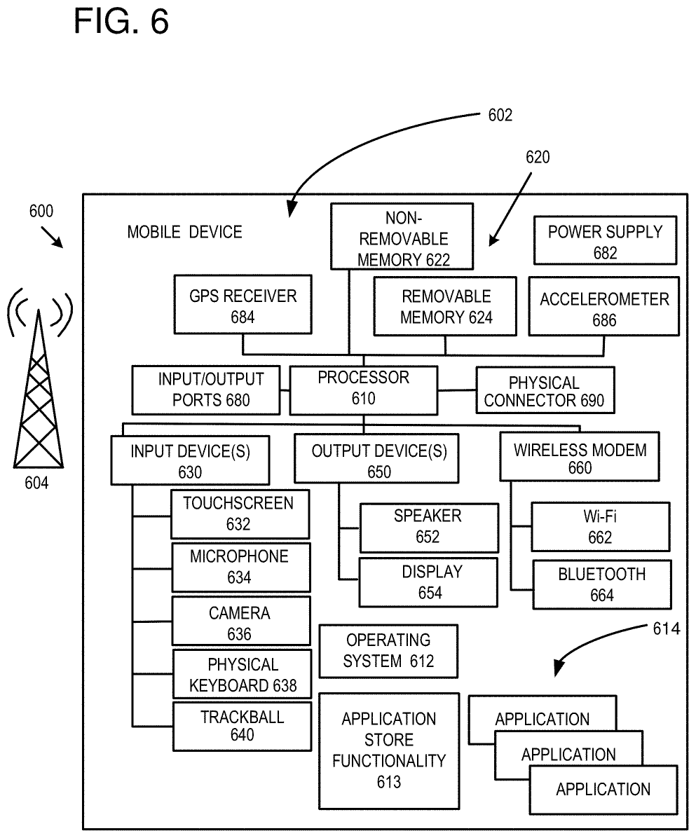

FIG. 6 is a system diagram depicting an example mobile device 600 including a variety of optional hardware and software components, shown generally at 602. Any components 602 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 604, such as a cellular, satellite, or other network.

The illustrated mobile device 600 can include a controller or processor 610 (e.g., signal processor, microprocessor, ASIC, or other control and processing logic circuitry) for performing such tasks as signal coding, data processing, input/output processing, power control, and/or other functions. An operating system 612 can control the allocation and usage of the components 602 and support for one or more application programs 614. The application programs can include common mobile computing applications (e.g., email applications, calendars, contact managers, web browsers, messaging applications), or any other computing application. Functionality 613 for accessing an application store can also be used for acquiring and updating application programs 614.

The illustrated mobile device 600 can include memory 620. Memory 620 can include non-removable memory 622 and/or removable memory 624. The non-removable memory 622 can include RAM, ROM, flash memory, a hard disk, or other well-known memory storage technologies. The removable memory 624 can include flash memory or a Subscriber Identity Module (SIM) card, which is well known in GSM communication systems, or other well-known memory storage technologies, such as “smart cards.” The memory 620 can be used for storing data and/or code for running the operating system 612 and the applications 614. Example data can include web pages, text, images, sound files, video data, or other data sets to be sent to and/or received from one or more network servers or other devices via one or more wired or wireless networks. The memory 620 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 600 can support one or more input devices 630, such as a touchscreen 632, microphone 634, camera 636, physical keyboard 638 and/or trackball 640 and one or more output devices 650, such as a speaker 652 and a display 654. Other possible output devices (not shown) can include piezoelectric or other haptic output devices. Some devices can serve more than one input/output function. For example, touchscreen 632 and display 654 can be combined in a single input/output device.

The input devices 630 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 612 or applications 614 can comprise speech-recognition software as part of a voice user interface that allows a user to operate the device 600 via voice commands. Further, the device 600 can comprise input devices and software that allows for user interaction via a user's spatial gestures, such as detecting and interpreting gestures to provide input to a gaming application.

A wireless modem 660 can be coupled to an antenna (not shown) and can support two-way communications between the processor 610 and external devices, as is well understood in the art. The modem 660 is shown generically and can include a cellular modem for communicating with the mobile communication network 604 and/or other radio-based modems (e.g., Bluetooth 664 or Wi-Fi 662). The wireless modem 660 is typically configured for communication with one or more cellular networks, such as a GSM network for data and voice communications within a single cellular network, between cellular networks, or between the mobile device and a public switched telephone network (PSTN).

The mobile device can further include at least one input/output port 680, a power supply 682, a satellite navigation system receiver 684, such as a Global Positioning System (GPS) receiver, an accelerometer 686, and/or a physical connector 690, which can be a USB port, IEEE 1394 (FireWire) port, and/or RS-232 port. The illustrated components 602 are not required or all-inclusive, as any components can be deleted and other components can be added.

### Cloud-Supported Environment

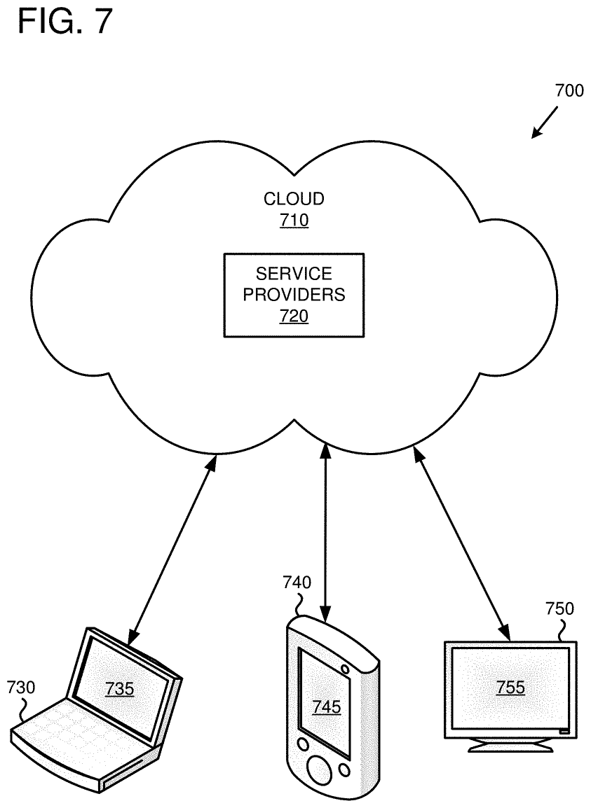

FIG. 7 illustrates a generalized example of a suitable cloud-supported environment 700 in which described embodiments, techniques, and technologies may be implemented. In the example environment 700, various types of services (e.g., computing services) are provided by a cloud 710. For example, the cloud 710 can comprise a collection of computing devices, which may be located centrally or distributed, that provide cloud-based services to various types of users and devices connected via a network such as the Internet. The implementation environment 700 can be used in different ways to accomplish computing tasks. For example, some tasks (e.g., processing user input and presenting a user interface) can be performed on local computing devices (e.g., connected devices 730, 740, 750) while other tasks (e.g., storage of data to be used in subsequent processing) can be performed in the cloud 710.

In example environment 700, the cloud 710 provides services for connected devices 730, 740, 750 with a variety of screen capabilities. Connected device 730 represents a device with a computer screen 735 (e.g., a mid-size screen). For example, connected device 730 could be a personal computer such as desktop computer, laptop, notebook, netbook, or the like. Connected device 740 represents a device with a mobile device screen 745 (e.g., a small size screen). For example, connected device 740 could be a mobile phone, smart phone, personal digital assistant, tablet computer, and the like. Connected device 750 represents a device with a large screen 755. For example, connected device 750 could be a television screen (e.g., a smart television) or another device connected to a television (e.g., a set-top box or gaming console) or the like. One or more of the connected devices 730, 740, 750 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 700. For example, the cloud 710 can provide services for one or more computers (e.g., server computers) without displays.

Services can be provided by the cloud 710 through service providers 720, or through other providers of online services (not depicted). For example, cloud services can be customized to the screen size, display capability, and/or touchscreen capability of a particular connected device (e.g., connected devices 730, 740, 750).

In example environment 700, the cloud 710 provides the technologies and solutions described herein to the various connected devices 730, 740, 750 using, at least in part, the service providers 720. For example, the service providers 720 can provide a centralized solution for various cloud-based services. The service providers 720 can manage service subscriptions for users and/or devices (e.g., for the connected devices 730, 740, 750 and/or their respective users).

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (i.e., any available computing device, including smart phones or other mobile devices that include computing hardware). Computer-readable storage media are tangible media that can be accessed within a computing environment (one or more optical media discs such as DVD or CD, volatile memory (such as DRAM or SRAM), or nonvolatile memory (such as flash memory or hard drives)). By way of example and with reference to FIG. 5, computer-readable storage media include memory 520 and 525, and storage 540. By way of example and with reference to FIG. 6, computer-readable storage media include memory and storage 620, 622, and 624. The term computer-readable storage media does not include signals and carrier waves. In addition, the term computer-readable storage media does not include communication connections, such as 570, 660, 662, and 664.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

1. A computing device comprising:
a processor; and
memory;
the computing device configured, via computer-executable instructions, to perform operations for preventing loss of notifications during network disconnections, the operations comprising:
determining that a client device has disconnected from a network communication channel between the computing device and the client device, wherein the network communication channel is not a push network communication channel;
for each of a plurality of notifications received for the client device while the client device is disconnected, wherein the notifications comprise ephemeral notifications wherein the ephemeral notifications are not persisted by service endpoints that originate the ephemeral notifications, wherein the ephemeral notifications are not re-transmitted by the service endpoints when the ephemeral notifications cannot be delivered to the client device, wherein the plurality of notifications also comprise non-ephemeral notifications that are persisted by service endpoints that originate the non-ephemeral notifications, and wherein the non-ephemeral notifications are re-transmitted by the service endpoints when the non-ephemeral notifications cannot be delivered to the client device:
determining a notification type of the notification;
based at least in part on the determined notification type, assigning a time-to-live (TTL) value to the notification, wherein different notification types are assigned different TTL values;
determining a notification class of the notification that indicates whether the notification is ephemeral or non-ephemeral;
determining a notification priority based at least in part on the notification type of the notification and the notification class of the notification; and
storing the notification in a message store in association with its assigned TTL value and its associated notification priority;
responsive to determining that the client device has reconnected to the network communication channel:
determining an order for sending the notifications stored in the message store to the client device, wherein determining the order is based at least in part on the TTL values and notification priorities of the notifications stored in the message store; and
sending, via the network communication channel, the notifications stored in the message store to the client device in the determined order.

2-3. (canceled)

4. The computing device of claim 1 wherein the network communication channel between the computing device and the client device is a persistent network communication channel.

5. The computing device of claim 1 wherein determining a notification type of the notification supports at least the following notification types:
a call ringing notification;
a presence change notification; and
a location update notification.

6-7. (canceled)

8. The computing device of claim 1 the operations further comprising:
for each of the plurality of notifications received for the client device while the client device is disconnected:
determining a notification size of the notification;
wherein the notification is stored in the message store in association with the determined notification size; and
wherein determining the order for sending the notifications is based at least in part on the notification sizes of the notifications stored in the message store.

9. The computing device of claim 1 the operations further comprising:
for each of the plurality of notifications received for the client device while the client device is disconnected:
determining a client device type of the client device;
wherein the notification is stored in the message store in association with the determined client device type; and
wherein determining the order for sending the notifications is based at least in part on the client device types associated with the notifications stored in the message store.

10. The computing device of claim 1 wherein the operations are performed by a notification transport service.

11. A method, implemented by a computing device, for preventing loss of notifications during network disconnections, the method comprising:
determining that a client device has disconnected from a network communication channel between the computing device and the client device, wherein the network communication channel is a persistent network communication channel and not a push network communication channel;
for each of a plurality of notifications received for the client device while the client device is disconnected, wherein the notifications comprise one or more ephemeral notifications wherein the ephemeral notifications are not persisted by service endpoints that originate the ephemeral notifications, wherein the ephemeral notifications are not re-transmitted by the service endpoints when the ephemeral notifications cannot be delivered to the client device, wherein the plurality of notifications also comprise non-ephemeral notifications that are persisted by service endpoints that originate the non-ephemeral notifications, and wherein the non-ephemeral notifications are re-transmitted by the service endpoints when the non-ephemeral notifications cannot be delivered to the client device:
determining a notification type of the notification;
based at least in part on the determined notification type, assigning a time-to-live (TTL) value to the notification, wherein different notification types are assigned different TTL values;
determining a notification class of the notification that indicates whether the notification is ephemeral or non-ephemeral;
determining a notification priority based at least in part on the notification type of the notification and the notification class of the notification; and
storing the notification in a message store in association with its assigned TTL value and its associated notification priority;
responsive to determining that the client device has reconnected to the network communication channel:
determining an order for sending the notifications stored in the message store to the client device, wherein determining the order is based at least in part on the TTL values and notification priorities of the notifications stored in the message store; and
sending, via the network communication channel, the notifications stored in the message store to the client device in the determined order.

12. (canceled)

13. The method of claim 11 wherein determining a notification type of the notification supports at least the following notification types:
a call ringing notification;
a presence change notification; and
a location update notification.

14-15. (canceled)

16. The method of claim 11 further comprising:
for each of the plurality of notifications received for the client device while the client device is disconnected:
determining a notification size of the notification;
wherein the notification is stored in the message store in association with the determined notification size; and
wherein determining the order for sending the notifications is based at least in part on the notification sizes of the notifications stored in the message store.

17. The method of claim 11 further comprising:
for each of the plurality of notifications received for the client device while the client device is disconnected:
determining a client device type of the client device;
wherein the notification is stored in the message store in association with the determined client device type; and
wherein determining the order for sending the notifications is based at least in part on the client device types associated with the notifications stored in the message store.

18. A method, implemented by a computing device, for preventing loss of notifications during network disconnections, the method comprising:
determining that a client device has disconnected from a network communication channel between the computing device and the client device, wherein the network communication channel is not a push network communication channel;
for each of a plurality of notifications received for the client device while the client device is disconnected, wherein the notifications comprise ephemeral notifications, wherein the ephemeral notifications are not persisted by service endpoints that originate the ephemeral notifications, wherein the ephemeral notifications are not re-transmitted by the service endpoints when the ephemeral notifications cannot be delivered to the client device, wherein the plurality of notifications also comprise non-ephemeral notifications that are persisted by service endpoints that originate the non-ephemeral notifications, and wherein the non-ephemeral notifications are re-transmitted by the service endpoints when the non-ephemeral notifications cannot be delivered to the client device:
determining a notification type of the notification;
based at least in part on the determined notification type, assigning a time-to-live (TTL) value to the notification, wherein different notification types are assigned different TTL values;
determining a notification class of the notification that indicates whether the notification is ephemeral or non-ephemeral;
determining a notification priority based at least in part on the notification type of the notification and the notification class of the notification; and
storing the notification in a message store in association with its assigned TTL value and its associated notification priority;
responsive to determining that the client device has reconnected to the network communication channel:
determining an order for sending the notifications stored in the message store to the client device, wherein determining the order is based at least in part on the TTL values and notification priorities of the notifications stored in the message store; and
sending, via the network communication channel, the notifications stored in the message store to the client device in the determined order.

19. The method of claim 18, wherein the network communication channel is a persistent network communication channel, the method further comprising:
for each of the plurality of notifications received for the client device while the client device is disconnected:
determining a notification size of the notification;
wherein the notification is stored in the message store in association with the determined notification size; and
wherein determining the order for sending the notifications is based at least in part on the notification sizes of the notifications stored in the message store.

20. The method of claim 18, wherein the network communication channel is a persistent network communication channel, the method further comprising:
for each of the plurality of notifications received for the client device while the client device is disconnected:
determining a client device type of the client device;
wherein the notification is stored in the message store in association with the determined client device type; and
wherein determining the order for sending the notifications is based at least in part on the client device types associated with the notifications stored in the message store.

21. The method of claim 18 wherein determining a notification type of the notification supports at least the following notification types:
a call ringing notification;
a presence change notification; and
a location update notification.

22. The computing device of claim 1 wherein the determined notification type of the notification is a call ringing notification, and wherein the call ringing notification is an ephemeral notification.
